(19) United States
(12) Patent Application Publication
(10) Pub. No.: US 2022/0058659 A1
(43) Pub. Date: Feb. 24, 2022

(54) System and Method for Location Awareness of Workers to Enhance Safety and Productivity

(71) Applicant: Niranjan Shrestha, Brooklyn, NY (US)

(72) Inventor: Niranjan Shrestha, Brooklyn, NY (US)

(21) Appl. No.: 17/407,769

(22) Filed: Aug. 20, 2021

Related U.S. Application Data
(60) Provisional application No. 63/068,275, filed on Aug. 20, 2020.

(51) Int. Cl. G06Q 30/00; G06Q 10/06; G06K 19/07; G08B 5/22; H04W 4/029; H04L 29/08

(52) U.S. Cl. CPC G06Q 30/018; G06Q 10/0639; H04L 67/306; G08B 5/22; H04W 4/029; G06K 19/0723

(57) ABSTRACT

Disclosed is a system and a method for location awareness of workers to enhance safety and productivity.

The current application claims a priority to the U.S. provisional patent application Ser. No. 63/068,275 filed on Aug. 20, 2021.

### FIELD OF THE INVENTION

The present invention generally relates to monitoring and tracking systems and methods. More specifically, the present invention provides a location awareness system and method for the construction industry to enhance worker safety and productivity.

### BACKGROUND OF THE INVENTION

There are many issues with worker location awareness, safety, and productivity in the construction industry. Construction sites are usually prone to accidents where one or more workers can get injured and the project team is often notified of the accident too late. For instance, the notification arrives with high time latency while the one or more workers are injured, which can result in dangerous consequences. The second issue with construction projects is productivity since productivity is usually not calculated for each worker. Individual worker productivity tracking can be costly and time consuming, which makes tracking the performance of each worker unpractical.

An objective of the present invention is to provide an Internet of Things (IoT) and Artificial Intelligence (AI) based system and method that enhances location awareness, safety, and productivity in the construction industry. The present invention, preferably referred to as Kwant AI, includes wearable device to be worn on the job site by every subject entering a construction site or any desired location to be monitored. Each smart badge has multiple varieties of sensors incorporated within as well as a unique identification (ID) code. In addition, the wearable device are linked to a network of controller, preferably referred to as the Kwant, that is placed on the construction site and is connected to a gateway. The data transmitted to the gateway from the Kwant is collected and sent to the Kwant AI servers on a cloud computing platform such as the Amazon Web Services platform. The data stored on the Kwant AI servers can be accessed through a user dashboard, preferably referred to as the OnTarget Platform/Dashboard. There, authorized users can perform various tasks or actions to monitor the actions and performance of the individual workers as well as to be notified of any emergency or similar situation where management or other authorized users need to intervene. Additional features are further discussed in the following sections.

### BRIEF DESCRIPTION OF THE DRAWINGS

FIG. 1 is an illustration showing the plurality of wearables devices (i.e., smart badges or wrist bands), network of controllers, and the gateway of the present invention.

FIG. 2 is an illustration showing a method of installing one or more controllers throughout a work site.

FIG. 3 is an illustration showing a method of determining the location of a user in a work site wearing a smart badge.

FIG. 4 is an illustration showing the proximity alert feature of the present invention using the plurality of smart badges or wearables.

FIG. 5 is an illustration showing the online dashboard of the present invention.

### DETAILED DESCRIPTION OF THE INVENTION

All illustrations of the drawings are for the purpose of describing selected versions of the present invention and are not intended to limit the scope of the present invention.

The present invention provides systems and methods for location awareness of workers to enhance safety and productivity. The present invention enables the individual monitoring of users present on a designated location such as a work site to determine the location and status of the individual users as well as to track the performance of each user. In a preferred embodiment, the present invention comprises a plurality of a wearable device specifically a smart badge, a controller, a gateway, a computing platform, and a user interface. The plurality of wearable device enables the remote tracking and monitoring of the users wearing the badges. The controller serves as a central hub to which the plurality of wearable device is connected to. The gateway transmits the collected data from the controller to the computing platform. The computing platform stores all the data received to be processed and be accessed by the authorized users. The user interface enables authorized users to access the data stored in the computing platform.

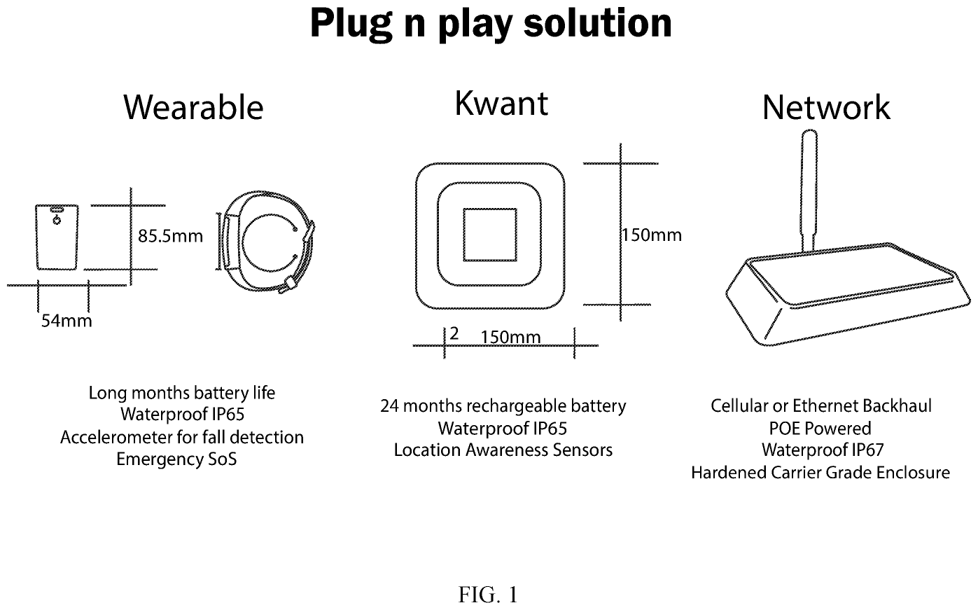

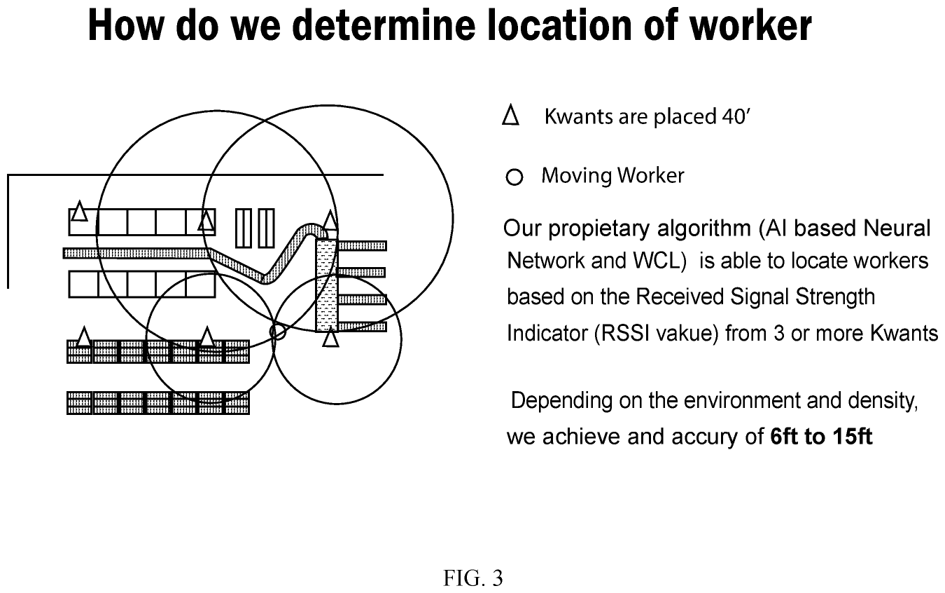

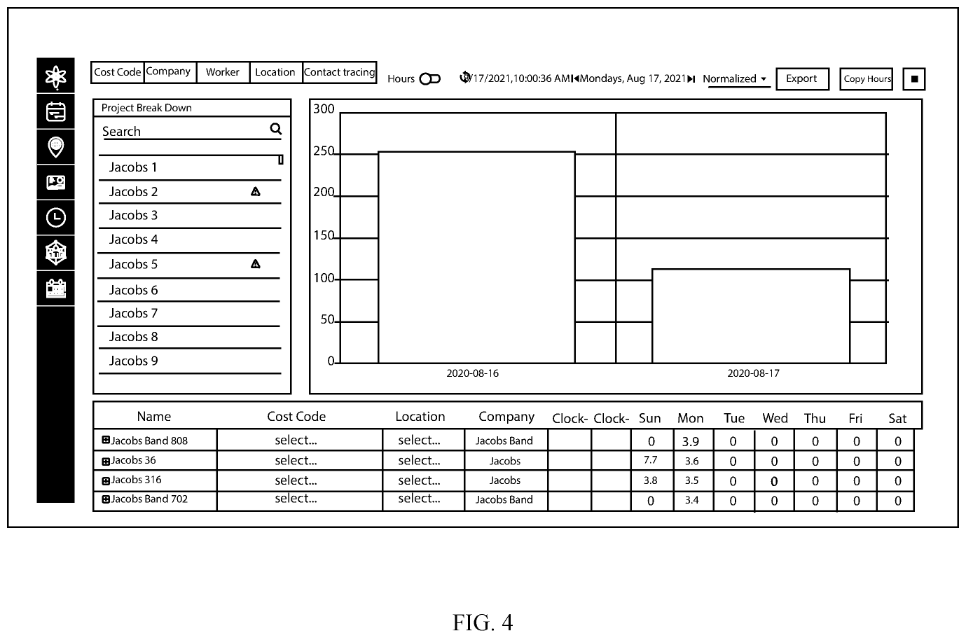

The aforementioned components enable the enhancement of safety and productivity of workers in construction site or similar locations. As can be seen in FIG. 1, the plurality of wearable device comprises multiple wearable devices equipped with short wireless communication capabilities to wireless transmit data to the control. In the preferred embodiment, the plurality of wearable device utilizes Bluetooth Low Energy (BLE) and Lora protocols to transmit data to the controller. Further, the BLE and Lora protocols are used to capture the information from the construction project, manufacturing warehouse, transportation system, or supply chain system. Each of the wearable device of the plurality of wearable device comprises a beacon ID which helps identify the individual user. Further, each of the wearable device of the plurality of wearable device continuously transmits data through the BLE and Lora protocols to the controller. As can be seen in FIG. 1-3, the plurality of wearable device along with the controller utilizes a plurality of sensors integrated within each of the wearable device as well as the controller to determine the location of the individual wearable device corresponding to the location of the users wearing the wearable device. For example, the internal and/or external location each user can be determined and tracked using the position and orientation of the smart badge relative to the position of the controller or a predetermined site layout. In the preferred embodiment, the indoor positioning of a smart badge is determined using a mixture of two methods: Weighted Centroid Localization (WCL) and Fingerprinting using Neural Network (FNN). Furthermore, the motion of each of the wearable device can be calculated to determine the movement of the subject. As can be seen in FIG. 3-4, authorized users or individual users can choose to enable motion tracking. In alternate embodiments, additional data or information about the individual user can be tracked and recorded by the present invention.

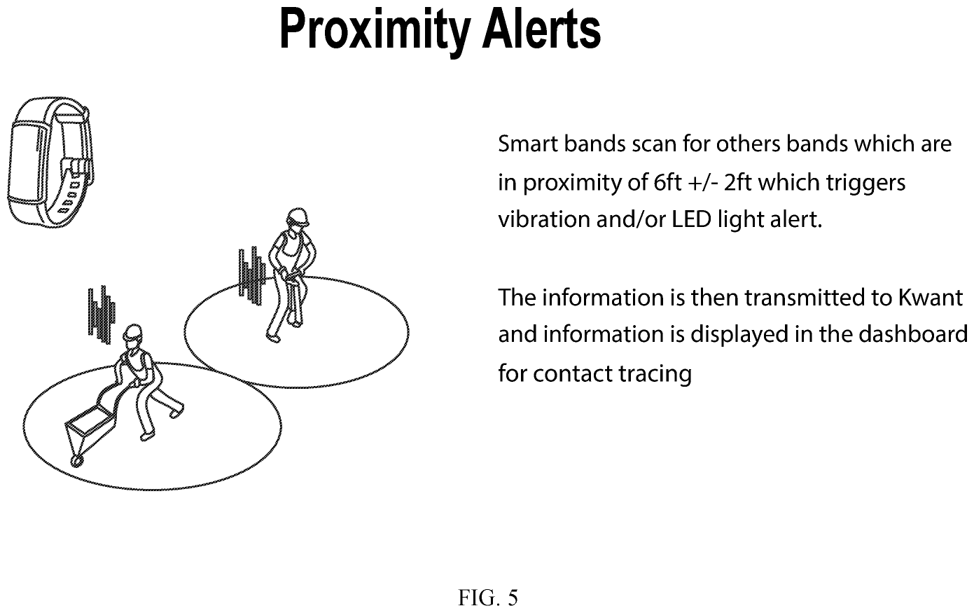

As can be seen in FIG. 1, the data collected by the controller from the plurality of smart badges and transmitted to the gateway is then sent to the cloud, which is later collected on the OnTarget platform. In the preferred embodiment, the OnTarget platform is the computing platform preconfigured to process and analyze the data according to predetermined protocols and settings. As can be seen in FIG. 3-4, the OnTarget platform is configured to provide a plurality of alerts that adhere to the ethos of the company to ensure the safety and productivity of the individual users. The OnTarget platform utilizes a unique notification system to provide warnings to all the necessary parties in the project. The notification system works with the complete integration of each user's respective contact details integrated on the OnTarget platform to the user's individual and ongoing project. In case of an alert, like a worker accident or issue, all the subjects in the project will be notified through a direct message or similar notification method. In alternate embodiments, the OnTarget platform can utilize different methods of notifying appropriate users of any critical event. Using an accelerometer on the wearable device, the OnTarget platform determines if the worker is showing anomaly in movement or jumps from authorized heights. Using a push button, the OnTarget platform sends the location of the wearable and the worker in the construction jobsite in case of an accident for immediate resume, as can be seen in FIG. 5.

In addition to the plurality of alerts regarding user safety, the OnTarget platform further monitors other environmental parameters, such as environmental factors and natural hazards that could affect the health, safety of the subject, and the project associated. As can be seen in FIG. 4, each of the plurality of wearable devices comprises an alarm mechanism that notifies the user wearing the smart badge of any alarm or event. For example, the alarm mechanism can indicate the project manager of any hazard like an earthquake or machinery failure that could pose a risk to the project and the individual workers. Furthermore, the plurality of wearable devices can help detect the type of accident or injury experienced by one or more workers. In the preferred embodiment, each smart badge of the plurality of wearable device comprises a plurality of sensors designed to detect slips and falls. As can be seen in FIG. 1, the plurality of sensors can include acceleration and/or gyro sensors designed to monitor and detect any slip and fall experienced by the individual user. Each smart badge of the plurality of wearable devices is configured to detect the change in motion, tapping system, or any other recognition system based on the platform settings. In alternate embodiments, the OnTarget platform and the plurality of wearable devices can be configured to detect other threats to the safety and health of the individual workers.

In the preferred embodiment, the platform is further configured to comply with any organizational, local, state, federal, or international laws or regulations. The platform can meet compliance for certificates, security, and necessary certificates for each subject's certificates. Further, the platform enables authorized users to upload the respective documents before starting the work assigned on the job site. For example, Occupational Safety and Health Administration (OSHA) certification is required for every worker on-site. Thus, every user is notified to upload the respective OSHA certification. In addition, all paperwork and documentation can be easily accessed through the platform to authorized users. Enabling the ease of access provides an automated solution for tracking the accreditation for the individual users. In alternate embodiments, the present invention can accommodate other documentation or paperwork necessary for the job to meet specific laws and regulations.

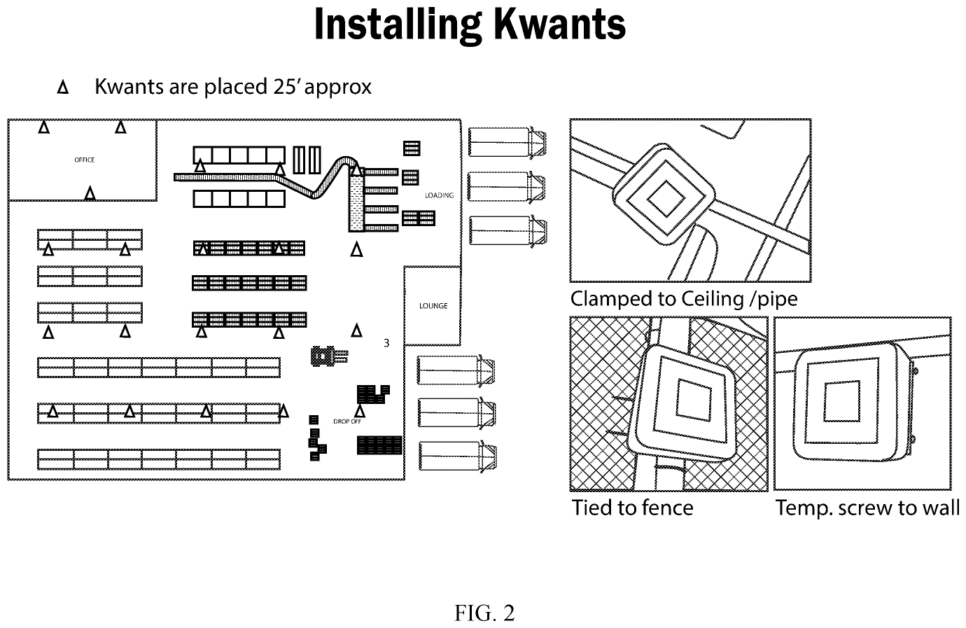

In addition to ensuring the safety of the individual users, the present invention further ensures and enhances the productivity of each user. In the preferred embodiment, the platform of the present invention utilizes the location tracking and monitoring capabilities of the controller to ensure each user is working on the user's assigned task. For example, users working in the wrong area can be detected and notified to move to the appropriate location. As can be seen in FIG. 2, each project site is divided into multiple zones, and nearly every zone has a Kwant (controller) placed for receiving the signals from the plurality of wearable device. Due to the location-based plurality of sensors present in the individual smart badge, the location of the individual user can be tracked for optimal performance. Further, each user's location can be analyzed on a daily track feature on the platform to determine the user's overall performance of the user's work on-site. In alternate embodiments, the present invention can be modified to accommodate other performance tracking features of the individual workers.

In the preferred embodiment, the computing platform and user interface enables authorized users to analyze the location of the individual worker versus the planned area of work on a specific day and time range. As can be seen in FIG. 2-3, the planned area of work can be preferably derived from the project schedule or other project details or requirements. In the preferred embodiment, if the location of the worker is different from the planned area of work, then the worker's actions are considered as unproductive work. The computing platform analyzes the locations of the individual workers and groups the data by productive, semi-productive, and unproductive areas. Further, the different areas or zones are preferably defined on the floor plan or site plan of a project at the start of the project. In addition, the predetermined areas or zones can be created for the term of the project or a specific period. The results of analysis will depend on data and definition of the period.

In addition to the location tracking to determine productivity of the individual workers, the computing platform further enables the establishment of the most optimal number of users required for any activity. In the preferred embodiment, the data of each worker on-site is collected based on the activities, which is further grouped into what activity was. An algorithm and multiple functions provide optimized recommendations through predictive analytics. The optimized recommendations provide effective cost and time solutions for the individual projects. Furthermore, the computing platform and the user interface enable accurate resource planning, budgeting, and payroll for each project. For example, the computing platform provides a clock-in and clock-out feature enabled by the automated tracking feature of the plurality of smart budges. Each smart badge of the plurality of wearable device detects the entry and exit time of the individual worker on-site. The automated clock-in and clock-out feature provides the total number of hours for each individual worker. In addition, due to the automated process of collecting the total work time that a worker has spent on-site enables the calculation of the individual worker's wage. In alternate embodiments, the present invention can accommodate other project planning, tracking, and budgeting features that enhance on-site productivity.

Although the invention has been explained in relation to its preferred embodiment, it is to be understood that many other possible modifications and variations can be made without departing from the spirit and scope of the invention.

What is claimed is:

1. A method for location awareness of workers to enhance safety and productivity, the method comprising the steps of:
providing a plurality of a wearable device, a controller, a gateway, a computing platform, and a user interface;
providing a plurality of user profiles, wherein each user profile is associated with a corresponding wearable device from the plurality of wearable devices;
collecting tracking data for each user profile with the corresponding wearable device;
relaying the tracking data for each user profile from the corresponding wearable device, through the gateway, to the computing platform;
processing the tracking data of each user profile in order to identify at least one workplace hazard for at least one specific user profile from the plurality of user profiles; and
outputting a warning notification with the user interface, wherein the warning notification includes the workplace hazard and the specific user profile.

2. The method for location awareness of workers to enhance safety and productivity, the method as claimed in claim 1, wherein each of the plurality of wearable devices is a smart badge.
